(19) United States
(12) Patent Application Publication
(10) Pub. No.: US 2009/0245072 A1
(43) Pub. Date: Oct. 1, 2009

(54) OPTICAL PICKUP APPARATUS

(75) Inventors: Kenji Asano, Gifu (JP); Tetsuhisa Hosokawa, Aichi (JP); Seiji Kajiyama, Gifu (JP)

Correspondence Address: FISH & RICHARDSON P.C., P.O. BOX 1022, MINNEAPOLIS, MN, 55440-1022, US

(73) Assignees: Sanyo Electronic Co., Ltd., Osaka (JP); Sanyo Optec Design Co., Ltd., Tokyo (JP)

(21) Appl. No.: 12/413,229

(22) Filed: Mar. 27, 2009

(30) Foreign Application Priority Data
Mar. 28, 2008 (JP) 2008-085825

(51) Int. Cl. G11B 7/135

(52) U.S. Cl. 369/112.23; G9B/7.112

(57) ABSTRACT

An optical-pickup apparatus comprising: a laser diode to emit laser light forward and backward; an objective lens to focus the laser light emitted forward from the laser diode onto a signal-recording layer of an optical disc; a spherical-aberration correction element that is arranged on an optical path between the laser diode and the objective lens, and is so movable in an optical-axis direction of the laser light as to correct spherical aberration; a movement-position detection unit to detect a movement position of the spherical-aberration correction element, and output a detection signal indicating the movement position of the spherical-aberration correction element; a photodetector to receive the laser light emitted backward from the laser diode, and output a monitor signal corresponding to a light-receiving level of the laser light; and a control unit to control intensity of the laser light emitted from the laser diode based on the monitor and detection signals.

### CROSS-REFERENCE OF RELATED APPLICATION

This application claims the benefit of priority to Japanese Patent Application No. 2008-085825, filed Mar. 28, 2008, of which full contents are incorporated herein by reference.

### BACKGROUND OF THE INVENTION

1. Field of the Invention

The present invention relates to an optical pickup apparatus that executes an operation of reading a signal recorded in an optical disc or an operation of recording a signal in the optical disc with laser light.

2. Description of the Related Art

Optical disc devices has been widespread each of which is capable of a signal reading operation and signal recording operation by applying laser light emitted from an optical pickup apparatus to a signal recording layer of the optical disc.

The optical disc devices using optical discs called CDs or DVDs are available in general, however, optical discs whose recording densities are improved, that is, those using Blu-ray standard optical discs have recently been developed.

Infrared light with a wavelength of 780 nm is used as the laser light executing the operation of reading a signal recorded in a CD standard optical disc, and red light with a wavelength of 650 nm is used as the laser light executing the operation of reading a signal recorded in a DVD standard optical disc.

In contrast to cases of such CD-standard and DVD-standard optical discs, laser light with a short wavelength, or a blue-violet light with a wavelength of 405 nm, for example, is used as the laser light executing the operation of reading a signal recorded in a Blu-ray standard optical disc.

The thickness is 0.1 mm of a protective layer provided on an upper surface of the signal recording layer in the Blu-ray standard optical disc, and the numerical aperture is specified at 0.85 of an objective lens used for the operation of reading a signal from this signal recording layer.

For such an optical pickup apparatus compliant with the optical disc standard with improved recording density, strict optical characteristics are required to improve signal recording quality in accordance with improvement in the recording density.

The optical pickup apparatus is made up such that a driving current to be supplied to a laser diode can be controlled so as to be able to obtain a laser output suitable for reading a signal recorded in the optical disc or a laser output suitable for recording a signal in the optical disc. The above operation of controlling the laser output is performed such that a monitor signal, which is obtained from a front monitor photodetector provided at a position where the laser light emitted forward from the laser diode is applied, is fed back to a driving circuit for supplying the driving current to the laser diode, as known.

In an optical pickup apparatus, aberration called spherical aberration is caused by a thickness of a protective layer between an incident face and a signal recording layer of an optical disc, and there is a problem that if the spherical aberration becomes larger, a signal reproducing operation or a signal recording operation can not normally be carried out. Thus, technologies to solve such a problem have been developed (See Japanese Patent Laid-Open Publication No. 2006-147069).

In recent optical discs, a multi-layer optical disc has been manufactured which includes a plurality of signal recording layers in order to increase a signal recording capacity. In such a multi-layer optical disc, the thicknesses of the protective layers differ according to the signal recording layers to be used.

When the multi-layer optical disc is used, the thickness of the protective layer is greatly changed each time the signal recording layer to be used is changed, and thus, the spherical aberration occurs. However, such spherical aberration can be corrected if the technology described in the above-mentioned patent document is employed.

FIG. 2 shows an optical pickup apparatus including such an aberration correcting element. In this figure, a laser diode 1 emits laser light forward, which is blue-violet light with a wavelength of 405 nm, for example, and the laser light emitted from the laser diode 1 enters a diffraction grating 2 and the diffraction grating 2 includes a diffraction grating portion 2a that divides the laser light into a main beam, which is 0th order light, and two sub beams, which are +1st order diffracted light and −1st order diffracted light, and a half-wave plate 2b that converts the incident laser light into a linearly polarized light in an S direction, for example.

The laser light having passed through the diffraction grating 2 enters a polarization beam splitter 3, and the polarization beam splitter 3 includes a control film 3a that reflects the S-polarized laser light, allows the laser light to pass therethrough, and allows the laser light converted into a linearly polarized light in a P direction to pass therethrough.

A quarter-wave plate 4 is provided at a position where the laser light reflected by the control film 3a of the polarization beam splitter 3 is incident and the quarter-wave plate 4 converts the incident laser light from linearly polarized light to circularly polarized light, or to the contrary, from the circularly polarized light to the linearly polarized light. The laser light having passed through the quarter-wave plate 4 enters a collimating lens 5, and the collimating lens 5 converts the incident laser light into parallel light and is moved by an aberration correction motor 6 in an optical axis direction, that is, directions of arrows A and B. The spherical aberration caused based on a thickness of a protective layer of an optical disc D is corrected by an operation of moving the collimating lens 5 in the optical axis direction.

At the collimating lens 5, diffraction grating 5a in a ring-shaped band shape as shown in FIGS. 2 and 3 is formed, and the collimating lens corrects chromatic aberration occurring in an objective lens, as will be described later, by the diffraction grating 5a. Such chromatic aberration occurs due to a change in wavelength of the laser light in response to a change in environmental temperature, and occurrence of the chromatic aberration adversely affects a focusing operation of the objective lens which focuses the laser light to a signal recording layer L included in the optical disc D.

A half mirror 7 is a raising half mirror that is provided at a position where the laser light having passed through the collimating lens 5 is incident, and reflects a part of the incident laser light in a direction of an objective lens 8 and has other part of the light to pass therethrough. A front monitor photodetector 9 is provided at a position where the laser light having passed through the raising half mirror 7 is applied, and is configured to output a signal corresponding to a level of the applied laser light as a monitor signal.

In the above configuration, the laser light emitted from the laser diode 1 is made incident on the objective lens 8 through the diffraction grating 2, the polarization beam splitter 3, the quarter-wave plate 4, the collimating lens 5, and the raising half mirror 7, and then, is applied as a spot on the signal recording layer L of the optical disc D by the focusing operation of the objective lens 8, while the laser light applied to the signal recording layer L is reflected as return light.

The return light reflected from the signal recording layer L of the optical disc D is incident on the control film 3a of the polarization beam splitter 3 through the objective lens 8, the raising half mirror 7, the collimating lens 5, and the quarter-wave plate 4. Since the return light incident on the control film 3a of the polarization beam splitter 3 as above has been converted into the linearly polarized light in the P direction by a phase change operation of the quarter-wave plate 4, the return light is not reflected by the control film 3a but is allowed to pass therethrough as control laser light.

The control laser light having passed through the control film 3a of the polarization beam splitter 3 enters a sensor lens 10 and the sensor lens 10 adds astigmatism to the control laser light to be applied to a light receiving portion included in a photodetector 11 called PDIC. In the photodetector 11, a known four-divided sensor, etc., are included and the photodetector 11 is made up so as to perform a signal generation operation accompanied by the operation of reading a signal recorded in the signal recording layer L of the optical disc D by an application operation of the main beam, an operation of generating a signal for performing a focusing control operation by an astigmatic method, and an operation of generating a signal for performing a tracking control operation by an application operations of the two sub beams.

Since control operations for generating such various signals are well known, descriptions will be omitted.

The optical pickup apparatus is made up as mentioned above, and in such a configuration, the objective lens 8 is fixed to a lens holding frame (not shown) supported by four or six support wires on a base of the optical pickup apparatus so that movement operations can be performed in a perpendicular direction relative to a signal surface of the optical disc D, that is, a focusing direction, and in a radial direction of the optical disc D, that is, a tracking direction.

A focusing coil 12 is provided at the lens holding frame to which the objective lens 8 is fixed, and has a function of moving the objective lens 8 in the focusing direction in cooperation with a magnet fixed to the base. A tracking coil 13 is provided at the lens holding frame to which the objective lens 8 is fixed, and has a function of moving the objective lens 8 in the tracking direction in cooperation with the magnet fixed to the base.

Since there are well known a configuration of the optical pickup apparatus including the above-mentioned focusing coil 12 and the tracking coil 13, and focusing and tracking control operations with a driving operation of each coil, descriptions will be omitted.

A light detection signal generation circuit 14 generates: an RF signal, which is a signal obtained by the operation of reading a signal recorded in the signal recording layer of the optical disc D from a sensor that makes up the photodetector 11 and that receives the main beam; a focus error signal, which is a signal obtained from the sensor for receiving the main beam by the focusing operation of the laser light; and a tracking error signal, which is a signal obtained from sensors for receiving the sub beams by the tracking operation of the laser light.

A signal obtained from the front monitor photodetector 9 is input to a laser output detection circuit 15 and the laser output detection circuit 15 is made up so as to output a signal corresponding to a level of the input signal as a monitor signal.

Various signals output from the light detection signal generation circuit 14 and the laser output detection circuit 15 and the like are input to a pickup control circuit 16 and the pickup control circuit 16 performs various control operations of the optical pickup apparatus on the basis of each signal. A focus control signal output from the pickup control circuit 16 on the basis of the focus error signal output from the light detection signal generation circuit 14 is input to a focusing coil driving circuit 17, and the focusing coil driving circuit 17 is made up so as to supply a driving signal to the focusing coil 12. A tracking control signal output from the pickup control circuit 16 on the basis of the tracking error signal output from the light detection signal generation circuit 14 is input to a tracking coil driving circuit 18, and the tracking coil driving circuit 18 is made up so as to supply a driving signal to the tracking coil 13.

A laser diode driving circuit 19 supplies a driving signal to the laser diode 1 and the laser diode driving circuit 19 is made up so as to adjust a laser output with a control signal output from the pickup control circuit 16 on the basis of a monitor signal obtained from the laser output detection circuit 15. An aberration-correction motor driving circuit 20 corrects spherical aberration by moving the collimating lens 5 in the optical axis direction by supplying a driving signal to the aberration correction motor 6, and the aberration-correction motor driving circuit 20 is made up so as to be controlled by the pickup control circuit 16.

The optical pickup apparatus is configured as mentioned above, and an operation thereof will hereinafter be described.

When the operation is performed of reading a signal recorded in the signal recording layer L included in the optical disc D, a driving control signal is supplied from the pickup control circuit 16 to each of the circuits making up the optical pickup apparatus. A driving signal for obtaining the laser output set in advance for performing an accurate signal reading operation is supplied from the laser diode driving circuit 19 to the laser diode 1, so that the laser light with a desired output is emitted from the laser diode 1.

The laser light emitted from the laser diode 1 enters the diffraction grating 2, to be divided into the main beam and the sub beams by the diffraction grating portion 2a included in the diffraction grating 2, and to be converted into the linearly polarized light in the S direction by the half-wave plate 2b. The laser light having passed through the diffraction grating 2 enters the polarization beam splitter 3, to be reflected by the control film 3a included in the polarization beam splitter 3.

The laser light reflected by the control film 3a included in the polarization beam splitter 3 enters the quarter-wave plate 4 to be converted from the linearly polarized light into the circularly polarized light, and thereafter, the converted laser light enters the collimating lens 5. The laser light incident on the collimating lens 5 is converted into the parallel light, to be made incident on the raising half mirror 7.

A part of the laser light incident on the raising half mirror 7 is reflected by the raising half mirror 7, while other part of the laser light is allowed to pass through the raising half mirror 7, to be applied to the front monitor photodetector 9. The laser light reflected by the raising half mirror 7 enters the objective lens 8, and a focusing operation by the objective lens 8 is carried out.

The focusing operation of the laser light to the signal recording layer L by the objective lens 8 is carried out by performing an operation of moving the objective lens 8 closer to the optical disc D from a position away from the optical disc D, for example. Such an operation of moving the objective lens 8 is carried out by supplying the driving signal from the focusing coil driving circuit 17 to the focusing coil 12, and when the focusing operation to the signal recording layer L is carried out, the laser light reflected by the signal recording layer L enters the objective lens 8 from the side of the optical disc D as the return light.

The return light incident on the objective lens 8 enters the control film 3a included in the polarization beam splitter 3 through the raising half mirror 7, the collimating lens 5, and the quarter-wave plate 4. Since the return light incident on the control film 3a has been converted by the quarter-wave plate 4 into the linearly polarized light in the P direction, the light is not reflected by the control film 3a but all the light is allowed to pass therethrough as control laser light.

The control laser light which is the return light having passed through the control film 3a enters the sensor lens 10, and then, is added with astigmatism by the sensor lens 10, to be applied to a sensor portion included in the photodetector 11. As a result of irradiation of the control laser light to the photodetector 11, a detection signal can be obtained on the basis of a position and change in shape of applied spot of the main beam, from the four-divided sensor, which is the light receiving portion for the main beam, and the like included in the photodetector 11, and similarly, a detection signal can be obtained on the basis of positions and changes in shapes of applied spots of the sub beams, from the four-divided sensors, which are the respective light receiving portions for the sub beams, and the like included in the photodetector 11.

In such a state, the focus error signal and the tracking error signal generated from the light detection signal generation circuit 14 on the basis of the detection signal obtained from the photodetector 11 are input to the pickup control circuit 16. When the focus error signal and tracking error signal are input to the pickup control circuit 16, a control signal on the basis of each of the error signal is output to the focusing coil driving circuit 17 and the tracking coil driving circuit 18. As a result, since a control signal is supplied to the focusing coil 12 from the focusing coil driving circuit 17, the operation of moving the objective lens 8 is carried out in the focusing direction with the focusing coil 12, so that the focusing control operation can be performed of focusing the laser light to the signal recording layer L. Since a control signal is supplied to the tracking coil 13 from the tracking coil driving circuit 18, the operation of moving the objective lens 8 is carried out in the tracking direction with the tracking coil 13, so that the tracking control operation can be performed of making the laser light follow a signal track provided in the signal recording layer L.

Since the focusing control operation and the tracking control operation are carried out in the optical pickup apparatus as mentioned above, the operation can be performed of reading a signal recorded in the signal recording layer L of the optical disc D. A reproduction signal obtained by such a reading operation can be obtained as information data by demodulating an RF signal generated from the light detection signal generation circuit 14 in a known way.

The operation is performed of reading a signal recorded in the signal recording layer L included in the optical disc D as mentioned above, and in a state of performing such a reading operation, the collimating lens 5 provided as an aberration correcting element is made up so as to be moved to an operation position where spherical aberration with respect to the signal, recording layer L is minimized by a driving signal supplied to the aberration correction motor 6 from the aberration-correction motor driving circuit 20. Such an operation position setting operation may be performed to set the operation position at such a position that a value of jitter included in the reproduction signal becomes an optimal value or such a position that a level of an RF signal becomes the maximum, for example.

By performing the operation of moving the collimating lens 5 to the operation position as mentioned above, the operation can be performed of reading a signal recorded in the signal recording layer L included in the optical disc D in an optimal state.

While the above-mentioned signal reading operation is performed, a driving signal, by which a desired laser output can be obtained, is supplied to the laser diode 1 from the laser diode driving circuit 19 and a monitor signal output from the laser output detection circuit 15 on the basis of a signal obtained from the front monitor photodetector 9 is input to the pickup control circuit 16.

When the monitor signal output from the laser output detection circuit 15 is input to the pickup control circuit 16 as above, a control signal on the basis of a level of the monitor signal is supplied to the laser diode driving circuit 19 from the pickup control circuit 16. Therefore, if control is performed such that a level of a driving signal supplied to the laser diode driving circuit 19 from the pickup control circuit 16 becomes a predetermined value, an output of the laser light emitted from the laser diode 1 can be automatically controlled so as to become a desired level.

Such an operation is called a laser-light automatic output control operation, and description will be omitted.

As mentioned above, a laser output control operation and an aberration correcting operation are carried out in the optical pickup apparatus, and by moving the collimating lens 5 in the optical axis direction for correcting aberration, a divergence adjustment operation of the laser light is carried out. When such a laser light divergence adjustment operation is carried out, intensity of the laser light applied to the signal recording layer L of the optical disc D is changed with a change in an irradiation angle, etc., of the laser light relative to the objective lens 8.

In the optical pickup apparatus shown in FIG. 2, the front monitor photodetector 9 for monitoring the level of the laser light is provided at a position where the laser light having passed through the collimating lens 5, which is the aberration correcting element, is applied, that is, the front monitor photodetector 9 is provided at a position subjected to change in the output of the laser light in accordance with the movement of the collimating lens 5. Thus, change in the intensity of the laser light can be detected, which is changed with the movement of the collimating lens 5.

However, such optical pickup apparatus not only is more likely to have a restriction imposed on a mounting position of the front monitor photodetector 9 for monitoring the intensity of the laser light, since the front monitor photodetector 9 should be provided on the objective lens side, but also has a problem of a high price since the apparatus needs a mirror of a half-mirror type as a raising mirror.

### SUMMARY OF THE INVENTION

An optical pickup apparatus according to an aspect of the present invention, comprises: a laser diode configured to emit laser light forward and backward; an objective lens configured to focus the laser light emitted forward from the laser diode onto a signal recording layer of an optical disc; a spherical aberration correction element arranged on an optical path between the laser diode and the objective lens, the spherical aberration correction element being so movable in an optical axis direction of the laser light as to correct spherical aberration; a movement position detection unit configured to detect a movement position of the spherical aberration correction element, and to output a detection signal indicating the movement position of the spherical aberration correction element; a photodetector configured to receive the laser light emitted backward from the laser diode, and to output a monitor signal corresponding to a light-receiving level of the laser light; and a control unit configured to control intensity of the laser light emitted from the laser diode on the basis of the monitor signal and the detection signal.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating an optical pickup apparatus according to an embodiment of the present invention; and

FIG. 2 is a diagram illustrating a general optical pickup apparatus.

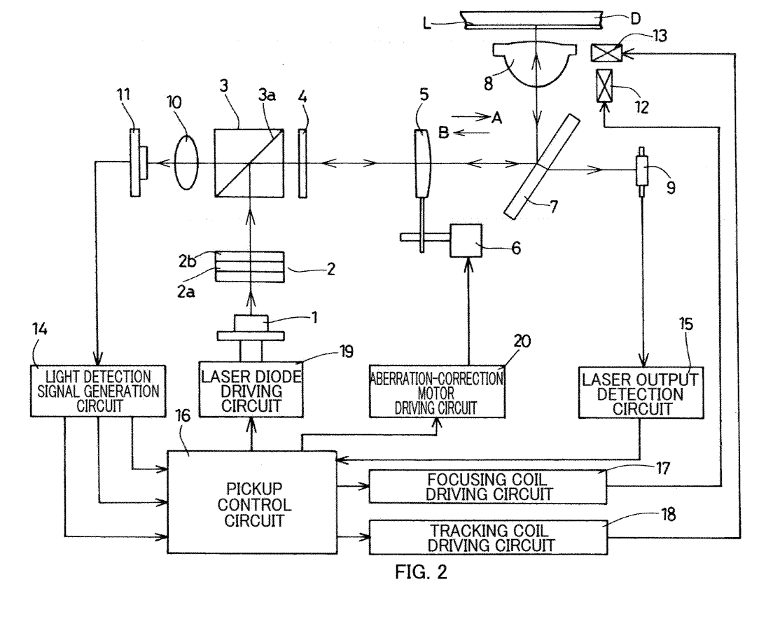

### DETAILED DESCRIPTION OF THE INVENTION

At least the following details will become apparent from descriptions of this specification and of the accompanying drawings.

An optical pickup apparatus according to an embodiment of the present invention includes: an aberration correction element that is provided on an optical path between a laser diode and an objective lens and that corrects spherical aberration by moving in an optical axis direction; a movement position detection unit that detects a movement position of the aberration correction element, where the movement position is a position on an optical path on which the aberration correction element is moved; and a laser light generating device including the laser diode and a back monitor photodetector that receives laser light emitted from the rear of the laser diode, and that outputs a detection output corresponding to a light-receiving level as a monitor signal, and controls an output of the laser light emitted from the laser diode by the monitor signal obtained from the back monitor photodetector as well as corrects the output of the laser light emitted from the laser diode on the basis of the movement position of the aberration correction element which is detected by the movement position detection unit.

In the optical pickup apparatus according to an embodiment of the present invention, a collimating lens is used as the aberration correction element, and the collimating lens is moved in the optical axis direction by a motor.

The optical pickup apparatus according to an embodiment of the present invention uses a stepping motor as the motor and a movement amount of the stepping motor is set by the number of driving pulses.

Moreover, the optical pickup apparatus according to an embodiment of the present invention detects the movement position of the collimating lens by detecting the number of driving pulses supplied to the stepping motor in the movement position detection unit, where the movement position is a position on an optical path on which the collimating lens is moved.

Furthermore, in the optical pickup apparatus according to an embodiment of the present invention, a memory for storing data indicating the movement position of the collimating lens and a correction amount of laser output corresponding to the movement position is provided so that the laser output is corrected on the basis of data obtained from the memory.

According to an optical pickup apparatus according to an embodiment of the present invention, even if intensity of the laser light is changed due to movement of the spherical aberration correction element, the laser output can be adjusted to a level suitable for a signal reading operation, etc.

Moreover, according to an optical pickup apparatus according to an embodiment of the present invention, since the laser light generating device including the laser diode and the back monitor photodetector is used so as to control the laser output with the monitor signal obtained from the back monitor photodetector, that is, since there is no need to provide a front monitor photodetector, not only that the number of restrictions can be reduced when designing component arrangement of an optical system, but also expensive components such as a raising half mirror and the like can be omitted. Therefore, not only that the optical pickup apparatus can be reduced in size but also the apparatus can be manufactured less expensively.

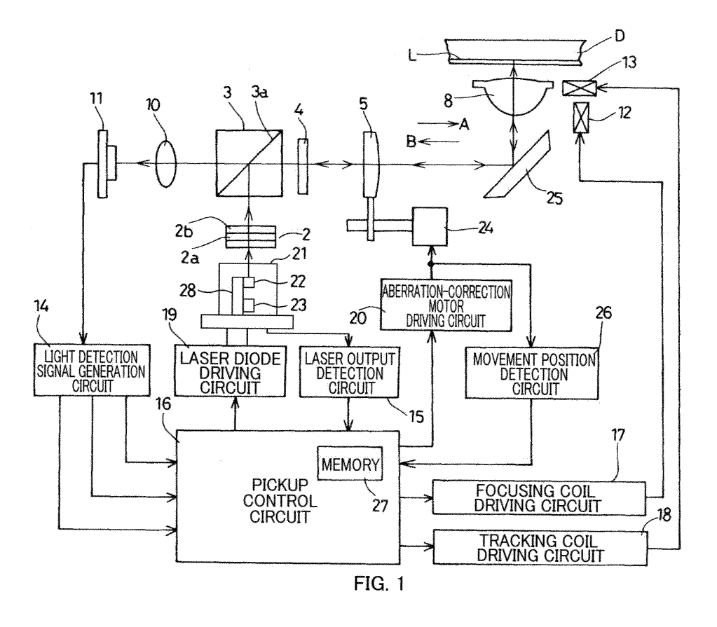

In FIG. 1, a laser light generating device 21 includes a laser diode 22 and a back monitor photodetector 23. The laser diode 22 emits laser light forward on the side of a diffraction grating 2 and backward on the side of the back monitor photodetector 23. The back monitor photodetector 23 is provided at a position where the laser light emitted backward from the laser diode 22 is applied and outputs a signal corresponding to a level of the applied laser light as a monitor signal. Inside the laser light generating device 21, the laser diode 22 and the back monitor photodetector 23 are arranged in parallel with the optical axis direction of the laser light by fixing the laser diode 22 and the back monitor photodetector 23 to a base 28 arranged in parallel with the optical axis direction of the laser light.

In such a configuration, the laser diode 22 emits the laser light in response to a driving signal supplied from a laser diode driving circuit 19. The monitor signal obtained from the back monitor photodetector 23 is output to the laser output detection circuit 15.

A stepping motor 24 is driven to move the collimating lens 5 in directions of A and B, which are optical axis directions. The stepping motor 24 is driven to rotate by a driving signal of a pulsed form supplied from an aberration correction motor driving circuit 20, and the rotation number of the stepping motor 24 is set corresponding to the number of pulse signals constituting the supplied driving signals.

The laser light having passed through the collimating lens 5 is incident on a raising mirror 25, and the mirror reflects the laser light in a direction of the objective lens 8. The raising mirror 25 also reflects return light incident from the side of the objective lens 8 in a direction of the collimating lens 5. A movement position detection circuit 26 detects the movement position of the collimating lens 5 by counting the number of driving signals supplied from the aberration correction motor driving circuit 20 to the stepping motor 24, that is, the number of pulses of the pulse signals, and outputs a signal indicating the detected movement position to a pickup control circuit 16.

A memory circuit 27 is provided in the pickup control circuit 16 and stores data indicating a relationship between the movement position of the collimating lens 5 and a correction amount of the driving signal supplied from the laser diode driving circuit 19 to the laser diode 22.

The optical pickup apparatus according to an embodiment of the present invention is configured as described above, and an operation of the optical pickup apparatus with the above configuration will be described below.

When an operation is performed of reading out a signal recorded in the signal recording layer L included in the optical disc D, a driving control signal is supplied to each of the circuits included in the optical pickup apparatus from the pickup control circuit 16. A driving signal for obtaining the laser output set in advance for performing an accurate signal reading operation is supplied from the laser diode driving circuit 19 to the laser diode 22, so that the laser light with a desired output is emitted from the laser diode 22.

The laser light emitted from the laser diode 22 enters the diffraction grating 2, to be divided into the main beam and the sub beams by the diffraction grating portion 2a included in the diffraction grating 2, and to be converted into the linearly polarized light in the S direction by the half-wave plate 2b. The laser light having passed through the diffraction grating 2 enters the polarization beam splitter 3, and the laser light is reflected by the control film 3a included in the polarization beam splitter 3.

The laser light reflected by the control film 3a included in the polarization beam splitter 3 enters the quarter-wave plate 4, to be converted from the linearly polarized light into the circularly polarized light, and thereafter, the converted laser light enters the collimating lens 5. The laser light incident on the collimating lens 5 is converted into the parallel light, to be made incident on the raising mirror 25.

The laser light incident on the raising mirror 25 is reflected by the raising mirror 25 to enter the objective lens 8, and the focusing operation with the objective lens 8 is carried out.

The focusing operation of the laser light to the signal recording layer L by the objective lens 8 is carried out by performing an operation of moving the objective lens 8 closer to the optical disc D from a position away from the disc, for example. Such an operation of moving the objective lens 8 is carried out by supplying a driving signal from the focusing coil driving circuit 17 to the focusing coil 12, and when the focusing operation to the signal recording layer L is carried out, the laser light reflected from the signal recording layer L to enters the objective lens 8 from the optical disc D side as return light.

The return light incident on the objective lens 8 enters the control film 3a included in the polarization beam splitter 3 through the raising mirror 25, the collimating lens 5, and the quarter-wave plate 4. Since the return light incident on the control film 3a has been converted by the quarter-wave plate 4 into the linearly polarized light in the P direction, the light is not reflected by the control film 3a but all the light is allowed to pass therethrough as control laser light.

The control laser light, which is the return light having passed through the control film 3a enters the sensor lens 10, and then, is added with astigmatism by the sensor lens 10 to be applied to a sensor portion included in the photodetector 11. As the result of irradiation of the control laser light to the photodetector 11, a detection signal can be obtained on the basis of a position and change in shape of applied spot of the main beam, from the four-divided sensor, which is the light receiving portion for the main beam, and the like included in the photodetector 11, and similarly, a detection signal can be obtained on the basis of positions and changes in shapes of applied spots of the sub beams, from the four-divided sensors, which are the respective light receiving portions for the sub beams, and the like included in the photodetector 11.

In such a state, a focus error signal and a tracking error signal generated from a light detection signal generation circuit 14 on the basis of the detection signal obtained from the photodetector 11 are input to the pickup control circuit 16. When the focus error signal and the tracking error signal are input to the pickup control circuit 16, a control signal on the basis of each error of the error signal is output to the focusing coil driving circuit 17 and a tracking coil driving circuit 18. As a result, since a control signal is supplied from the focusing coil driving circuit 17 to the focusing coil 12, the operation of moving the objective lens 8 is carried out in the focusing direction with the focusing coil 12, so that the focusing control operation can be performed of focusing the laser light to the signal recording layer L. Since a control signal is supplied from the tracking coil driving circuit 18 to the tracking coil 13, the operation of moving the objective lens 8 is carried out in the tracking direction with the tracking coil 13, so that the tracking control operation can be performed of making the laser light follow a signal track provided in the signal recording layer L.

Since the focusing control operation and the tracking control operation are carried out in the optical pickup apparatus as mentioned above, the operation can be carried out of reading a signal recorded in the signal recording layer L of the optical disc D. A reproduction signal obtained by such a reading operation can be obtained as information data by demodulating an RF signal generated from the light detection signal generation circuit 14 in a known way.

The operation is performed of reading a signal recorded in the signal recording layer L included in the optical disc D as mentioned above, and in a state of performing such a reading operation, the collimating lens 5 provided as the aberration correction element is made up so as to be moved to an operation position where spherical aberration of the objective lens 8 with respect to the signal recording layer L is minimized by the driving signal supplied from the aberration correction motor driving circuit 20 to the stepping motor 24. Such an operation position setting operation may be performed for the collimating lens 5 so as to set the operation position at such a position that a jitter value included in the reproduction signal becomes an optimal value or such a position that a level of an RF signal becomes the maximum, for example.

By performing the operation of moving the collimating lens 5 to the operation position where the spherical aberration of the objective lens 8 is minimized, as mentioned above, the operation can be performed of reading a signal recorded in the signal recording layer L included in the optical disc D in an optimal state.

While the above-mentioned signal reading operation is performed, a driving signal, by which a desired laser output can be obtained, is supplied from the laser diode driving circuit 19 to the laser diode 22, and a monitor signal output from the laser output detection circuit 15 is input to the pickup control circuit 16 on the basis of the signal obtained from the back monitor photodetector 23.

When the monitor signal output from the laser output detection circuit 15 is input to the pickup control circuit 16 as above, a control signal on the basis of a level of the monitor signal is supplied from the pickup control circuit 16 to the laser diode driving circuit 19. Therefore, if control is performed such that a level of a driving signal supplied from the pickup control circuit 16 to the laser diode driving circuit 19 becomes a predetermined value, an output of the laser light emitted from the laser diode 22 can be automatically controlled so as to become a desired level.

The laser-output control operation and the aberration correction operation are carried out in the optical pickup apparatus according to an embodiment of the present invention as mentioned above, and when the collimating lens 5 is moved in the optical axis direction for the aberration correction, a divergence adjustment operation of the laser light is carried out. When such laser light divergence adjustment operation is carried out, intensity of the laser light applied to the signal recording layer L of the optical disc D is changed with a change in an irradiation angle, etc., of the laser light relative to the objective lens 8. A change in the intensity of the laser light brings about a state where the operation of reading a signal recorded in the signal recording layer L of the optical disc D can not normally be carried out, however, the optical pickup apparatus according to an embodiment of the present invention is made up so as to correct the change the intensity of the laser light.

That is, there is a unique relationship between the movement amount of the collimating lens 5 in the optical axis direction and the change in the intensity of the laser light focused on the signal recording layer L with the objective lens 8, and data on the basis of such a relationship is stored in the memory circuit 27. An embodiment according to the present invention is configured such that the pulse number of the pulse signal supplied as the driving signal from the aberration correction motor driving circuit 20 to the stepping motor 24 are counted by the movement position detection circuit 26, to output a signal indicating the movement position of the collimating lens 5 determined on the basis of the above counted number from the movement position detection circuit 26 to the pickup control circuit 16.

When the signal indicating the movement position of the collimating lens 5 is output from the movement position detection circuit 26 to the pickup control circuit 16, data stored in the memory circuit 27 included in the pickup control circuit 16, that is, correction data of the laser output set corresponding the movement position of the collimating lens 5, is read, and an operation of correcting the laser driving signal on the basis of the data is carried out for the laser diode driving circuit 19.

As a result of such a correction operation, a magnitude is corrected of the driving signal supplied from the laser diode driving circuit 19 to the laser diode 22, so that an output of the laser light emitted from the laser diode 22 is corrected as well. Therefore, even if the operation position of the collimating lens 5 is changed in order to correct the spherical aberration of the objective lens 8, the intensity of the laser light emitted to the signal recoding layer L of the optical disc D can be corrected so as to become suitable for the operation of reading a signal.

As mentioned above, in the optical pickup apparatus according to an embodiment of the present invention, even if a thickness of a protective layer is changed with a change of a signal recording layer subjected to a signal reading operation as in a multi-layer optical disc including a plurality of signal recording layers, an operation of correcting laser intensity is carried out with an operation of correcting spherical aberration, and thus, an operation of reading a signal from each signal recording layer can accurately be carried out.

In an embodiment of the present invention, there is described a case of the operation of reading a signal recorded in the signal recording layer L of the optical disc D, however, a laser-output correction operation can similarly be carried out when an operation of recording a signal in the signal recording layer L is carried out.

Furthermore, in an embodiment of the present invention, the collimating lens that converts laser light into parallel light is used as a means for correcting spherical aberration, however, a lens called an expand lens can also be used as a matter of course.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a laser diode configured to emit laser light forward and backward;
an objective lens configured to focus the laser light emitted forward from the laser diode onto a signal recording layer of an optical disc;
a spherical aberration correction element arranged on an optical path between the laser diode and the objective lens, the spherical aberration correction element being so movable in an optical axis direction of the laser light as to correct spherical aberration;
a movement position detection unit configured to detect a movement position of the spherical aberration correction element, and to output a detection signal indicating the movement position of the spherical aberration correction element;
a photodetector configured to receive the laser light emitted backward from the laser diode, and to output a monitor signal corresponding to a light-receiving level of the laser light; and
a control unit configured to control intensity of the laser light emitted from the laser diode on the basis of the monitor signal and the detection signal.

2. The optical pickup apparatus according to claim 1, wherein
the control unit corrects the intensity of the laser light emitted from the laser diode on the basis of the detection signal, while controlling the intensity of the laser light emitted from the laser diode on the basis of the monitor signal.

3. The optical pickup apparatus according to claim 2, further comprising
a laser-light generating device including the laser diode and the photodetector.

4. The optical pickup apparatus according to claim 2, wherein
the spherical aberration correction element includes a collimating lens that the laser light emitted from the laser diode enters, that converts the laser light into parallel light, and that outputs the converted laser light.

5. The optical pickup apparatus according to claim 4, further comprising
a motor configured to move the collimating lens in the optical axis direction.

6. The optical pickup apparatus according to claim 5, wherein
the motor includes a stepping motor; and
a movement amount of the stepping motor is set by the number of driving pulses corresponding to a movement amount of the collimating lens in the optical axis direction.

7. The optical pickup apparatus according to claim 6, wherein
the movement position detection unit detects a movement position of the collimating lens on the basis of the number of the driving pulses supplied to the stepping motor.

8. The optical pickup apparatus according to claim 7, further comprising
a memory configured to store data indicating the movement position of the collimating lens and a correction amount of intensity of the laser light emitted from the laser diode corresponding to the moving position, wherein
the control unit corrects the intensity of the laser light emitted from the laser diode on the basis of the data read from the memory according to the detection signal.
